(19) United States
(12) Patent Application Publication
(10) Pub. No.: US 2006/0244993 A1
(43) Pub. Date: Nov. 2, 2006

(54) Shared print server control program and shared print server control method

(75) Inventor: Makoto Konnai, Tokyo-to (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/375,245

(22) Filed: Mar. 15, 2006

(30) Foreign Application Priority Data
Mar. 15, 2005 (JP) 2005-73561

(51) Int. Cl. G06F 3/12

(52) U.S. Cl. 358/1.15; 709/203

(57) ABSTRACT

A shared print server control program and a shared print server control method are disclosed. In addition to a standard spooler included in the operating system mounted on a server for managing the printing jobs based on the shared printer function, an additional spooler for assisting in the management of the printing jobs is arranged on the server. The additional spooler, after sequentially receiving all the printing jobs transmitted from the client, cuts off the communicative connection with the client immediately without waiting for the end of the processing operation of the previously receiving printing jobs. The additional spooler in operation transmits packets indicating that the additional spooler is in operation, to a predetermined communication port at predetermined intervals, and after starting the processing operation of the printing jobs, monitors the printer status. Upon occurrence of a printer error during the processing operation of the printing jobs, the error information is notified in accordance with a predetermined protocol to the client with a predetermined resident program installed therein. In this way, the operation of a shared printer system is realized.

### CROSS-REFERENCE TO RELATED APPLICATION

This subject is related to subject matter disclosed in Japanese Patent Application No. 2005-73561 filed on Mar. 15, 2005 in Japan to which the subject application claims priority under Paris Convention and which is incorporated herein by reference.

### BACKGROUND OF THE INVENTION

1. Field of the Invention

This invention relates to a shared print server control program and a shared print server control method for improving a shared print server control function included in the basic software, i.e. the operating system for managing the whole computer system.

2. Related Background Art

The current version Mac OS X® of the basic software, i.e. the operating system (OS) mounted on the personal computers Macintosh®, Power Macintosh®, Power Mac®, iMac®, eMac®, Mac mini®, iBook® and power Book® supplied by Apple Computer, Inc.® includes the function called “the shared printer” used in the printing process.

In using the “shared printer” function, a predetermined setting is carried out through a user interface (UI) provided by the operating system mounted on the Macintosh personal computer functioning as a print server (hereinafter referred to as the “server”). Then, the printing job transmitted from the other Macintosh personal computers (hereinafter referred to as the “clients”) connected to the server through a network is received by the server, and using a printer connected locally or through a network to the server, the printing based on the printing job is executed.

FIG. 5 is a block diagram showing a shared printer system configured of a server connected with a printer and a client connected to the server through a network.

The server 3 is connected with a printer 4 locally or through a network. Also, the server 3 is connected with a client 1 through the network 2. In FIG. 5, only one client 1 connected to the server 3 through a network is shown for simplification. Normally, however, a plurality of clients 1 are connected.

A file to be printed such as a document file or an image file is prepared or edited by an arbitrary application software 11 installed in the client 1, and a print execution instruction is input. Then, based on the image data generated by the application software 11, a graphic engine 13 produces a PDF file 14 for each page.

On the other hand, the application software 11 outputs a print request to a print API (application program interface) 12, and in response to this instruction, the print API 12 prepares a query or a job ticket to give a print request to the shared printer system, which is attached to the PDF file 14.

The client spooler (CUPS (common UNIX printing system)®) 15 included in the operating system mounted on the client 1 to manage the printing job based on the shared printer function transmits the PDF file 14 making up the printing job to the server 3 through the network 2 together with a query or a job ticket.

The standard spooler (CUPS) 31 included in the operating system mounted on the server 3 to manage the printing job based on the shared printer function, upon receipt of printing jobs from the client 1 through the network 2, converts the printing jobs sequentially to the raster data, which is transmitted to a back-end unit 32, which in turn outputs the raster data to the printer 4 as print data, and the printer 4 executes the printing operation based on the print data.

The above-mentioned shared printer system configured based on the standard function of “Mac OS X” is described in detail in the following official Web site of Apple Computer, Inc:

“About the Mac OS X Printing System” (http://developer.apple.com/documentation/Printing/Conceptual /About_MacOSX_Printing/Index.html or http://developer.apple.com/documentation/Printing/Conceptual/ About_MacOSX_Printing/prtfund.pdf)

In the shared printer system configured based on the standard function “Mac OS X” as described above, even during the operation of the printing job in the server 3, the communication connection between the server 3 and the client 1 is maintained, and in the case where some error occurs during the period before the end of the operation of the printing job, the error information is notified to the client 1.

A feature of this shared printer system lies in that the error information is displayed through a user interface included in the client 1 conveniently unlike Linux® using the CUPS as a printing frame work.

The shared printer system based on the standard function “Mac OS X”, however, has the following inconvenience due to the fact that the communication connection between the server 3 and the client 1 is maintained until the end of the operation of the printing job.

First, in the case where a plurality of clients try to transmit a plurality of printing jobs to the server, for example, each client cannot transmit a succeeding printing job before the printing job previously transmitted by the particular client is completely executed. Therefore, an emergency printing, if any, cannot be executed rapidly.

Secondly, after a printing job is transmitted from the client to the server, the communication connection between them is maintained and a job window indicating the progress of the printing job continues to be displayed on the client monitor until the end of the operation of the particular printing job. Even after the printing job is completely transmitted from the client to the server, therefore, the power of the client cannot be switched off until the end of the operation of the printing job.

Due to the inconveniences as described above, in the case where a plurality of clients try to transmit a plurality of printing jobs to the server at the same time and the plurality of the printing jobs are stagnated on the server, the usability and convenience of the client are extremely deteriorated.

Although this problem is caused by TIOGA which is a printing framework of “Mac OS X”, a similar problem is posed by a version in which the printing framework is replaced with an open source software CUPS.

Therefore, the above-mentioned problem is desirably solved by the improvement of the printing frame of “Mac OS X” in vain.

The printing framework of “Mac OS X”, however, is due to the design policy of “Mac OS X”, and should not be arbitrarily altered by vendors, etc.

A solution to the problem is desired strongly especially from the high-end users required to process a multiplicity of printing jobs, and a measure to solve the problem on the part of vendors without changing the printing framework of “Mac OS X” is desired.

While avoiding the aforementioned problem, the error information notification function is desirably held in which upon occurrence of some error before the end of the processing operation of a printing job, the error information is notified to the client.

### SUMMARY OF THE INVENTION

The object of this invention is to provide a shared print server control program and a shared print server control method in which the printing jobs are smoothly and rapidly processed as viewed from the client side without changing the standard function and the printing framework of the operating system while at the same time holding the error information notification function in a shared printer system.

According to the shared print server control program of the present invention, there is provided a shared print server control program used for a shared printer system including a server connected with a printer and at least one client connected to the server through a network, realizing an operation of the shared printer system in such a manner that:

an additional spooler for assisting in the management of printing jobs is arranged on the server in addition to a standard spooler included in the operating system mounted on the server for managing the printing jobs based on the shared printer function;

the additional spooler, upon sequential receipt of all the printing jobs transmitted from the client, cuts off the communication connection with the client without waiting for the end of the processing operation of the previously received printing jobs;

the additional spooler in operation transmits packets indicating that the additional spooler is in operation, to a predetermined communication port at predetermined intervals; and

the additional spooler monitors the printer status after starting the processing operation of the printing jobs, and upon occurrence of an error in the printer during the processing operation of the printing jobs, notifies the error information according to a predetermined protocol to the client with a predetermined resident program installed therein.

In the shared print server control program of the present invention, the resident program may be such that the print status display UI to display the printer status and the error information is arranged on the client.

The resident program may be such that the monitor operation is performed to determine whether the predetermined communication port receives the packets at predetermined intervals thereby to determine whether the additional spooler is in operation or the shared printer function of the operating system is valid.

The resident program may be such that upon determination that the result of the monitoring shows that the additional spooler is in operation on the server, the process of the printer status monitor displayed on the monitor of the client based on the shared printer function of the operating system is monitored, and upon activation of the process, a predetermined alarm is generated.

The resident program may be such that the alarm is stopped upon determination that the continuos monitor operation shows that the shared printer function of the operating system is valid.

The resident program is such that the printer status display UI on the client is rendered invisible upon determination that the continuos monitor operation shows that the shared printer function of the operating system is valid.

The additional spooler sequentially may transfer the received printing jobs to the standard spooler.

According to the shared print server control method of the present invention, there is provided a shared print server control method used for a shared printer system including a server connected with a printer and at least one client connected to the server through a network, comprising the steps of:

arranging an additional spooler on the server for assisting in the management of printing jobs in addition to a standard spooler included in the operating system on the server for managing the printing jobs based on the shared printer function;

the additional spooler in operation transmitting packets indicating that the additional spooler is in operation, to a predetermined communication port at predetermined intervals;

the additional spooler, upon transmission of the printing jobs from the client to the server, sequentially receiving all the printing jobs from the client without waiting for the end of the processing operation of the previously received printing jobs;

the additional spooler cutting off the communicative connection with the client immediately after sequentially receiving all the printing jobs transmitted from the client; and

the additional spooler monitoring the printer status after starting the processing operation of the printing jobs, and upon occurrence of an error in the printer during the processing operation of the printing jobs, notifying an error information in accordance with a predetermined protocol to the client with a predetermined resident program installed therein.

The shared print server control method according to the present invention may further comprise the step of the resident program being such that the printer status display UI for displaying the printer status and the error information is arranged on the server.

The shared print server control method according to the present invention may further comprise the step of the resident program monitoring whether the predetermined communication port receives the packets at predetermined intervals thereby to determine whether the additional spooler is in operation or the shared printer function of the operating system is valid.

The shared print server control method according to the present invention may further comprise the step of the resident program being such that upon determination that the result of the monitoring shows that the additional spooler is in operation on the server, the process of the printer status monitor displayed on the monitor of the client based on the shared printer function of the operating system is monitored, and upon activation of the process, a predetermined alarm is generated.

The shared print server control method according to the present invention may further comprise the step of the resident program stopping the alarm upon determination, as the result of continuous monitor operation, that the shared printer function of the operating system is valid.

The shared print server control method according to the present invention may further comprise the step of the resident program rendering the printer status display UI on the client invisible upon determination, as the result of continuous monitor operation, that the shared printer function of the operating system is valid.

The shared print server control method according to the present invention may further comprise the step of the additional spooler sequentially transferring the received printing jobs to the standard spooler.

### BRIEF DESCRIPTION OF THE DRAWINGS

FIG. 1 is a block diagram showing a shared printer system configured of a shared print server control program and a shared print server control method according to this invention;

FIG. 2 is a flowchart showing the operation steps for monitoring as to whether the “shared printer” function of the shared printer system is based on the shared print server control program and the shared print server control method according to the invention or on the “shared printer” function of the operating system;

FIG. 3 is a flowchart showing the operation steps for monitoring the process of the printer status monitor displayed on the monitor of the client 1 based on the “shared printer” function of the operating system;

FIG. 4 is a flowchart showing the operation steps for rendering the printer status display UI 16 on the client 1 invisible; and

FIG. 5 is a block diagram showing a shared printer system configured of a server connected with a printer and a client connected to the server through a network.

### DETAILED DESCRIPTION OF THE EMBODIMENTS

The shared print server control program and the shared print server control method according to an embodiment of the invention are described below with reference to the drawings.

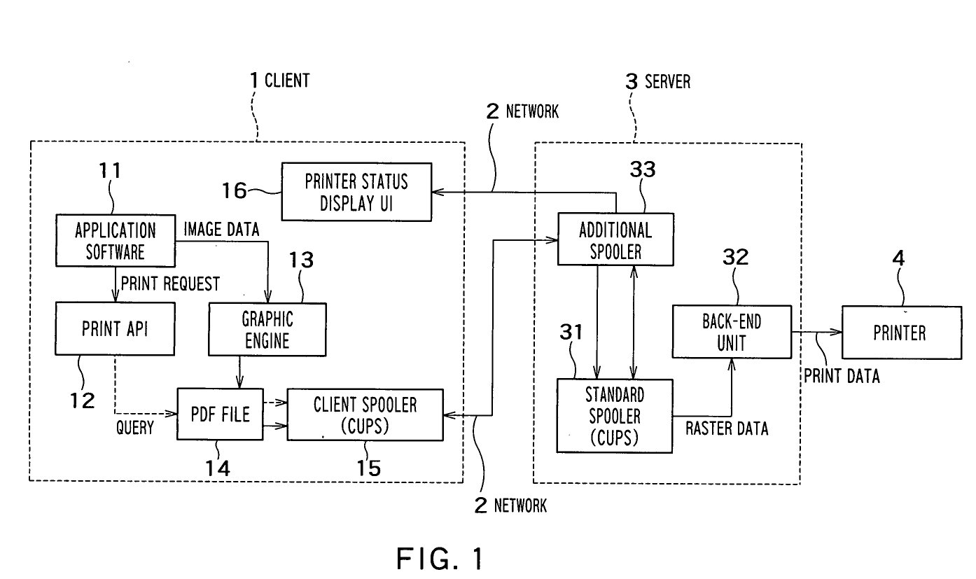

FIG. 1 is a block diagram showing a shared printer system configured of a shared print server control program and a shared print server control method according to this invention.

The shared printer system comprises a server 3 connected to a printer 4 locally or through a network and a client 1 connected to the server 3 through the network 2. In FIG. 1, only one client 1 connected to the server 3 through the network is shown for simplification. Normally, however, a plurality of clients 1 are connected.

The steps of operation before the transmission of a printing job from the client 1 to the server 3 are similar to those of the conventional shared printer system. First, a file such as a document file or an image file to be printed is created or edited by an arbitrary application software 11 installed in the client 1, and a print execution instruction is input. Then, based on the image data created by the application software 11, a graphic engine 13 produces a PDF file 14 for each page.

The application software 11, on the other hand, issues a print request to a print API 12, which in turn produces a query or a job ticket for giving a print request to the shared printer system and attaches it to the PDF file 14.

A client spooler (CUPS) 15 included in the operating system of the client 1 to manage the printing job based on the “shared printer” function transmits the PDF file 14 making up a printing job, together with the query and the job ticket, to the server 3 through a network 2.

In the shared printer system used with the shared print server control program and the shared print server control method according to this invention, an additional spooler 33 for assisting the printing job management is included in the server 3 in addition to the standard spooler (CUPS) 31 for managing the printing job based on the “shared printer” function.

Assume that a plurality of printing jobs are transmitted from a plurality of clients 1 to the server 3. The additional spooler 33 on the server 3 based on the shared print server control program and the shared print server control method according to this invention sequentially receives all the printing jobs without waiting for the end of the processing of the previously received printing jobs, cuts off the communication connection with each client 1 without delay or immediately and sequentially transfers a plurality of the received printing jobs to the standard spooler 31.

The additional spooler 33 receives all the printing jobs sequentially transmitted from the clients 1 without waiting for the end of the processing of the previously received printing jobs. The client 1 desirous of transmitting a plurality of printing jobs, therefore, while printing jobs are being transmitted also from other clients 1, can transmit the particular plurality of printing jobs rapidly without waiting for the end of the processing of the printing jobs previously transmitted by him/her. Thus, the transmission of an emergency printing job, if any, can be rapidly completed.

Also, the additional spooler 33, after sequentially receiving all the printing jobs transmitted from a given client 1, cuts off the communication connection with the particular client 1 without delay or immediately, and at the same time, the job window thus far displayed on the monitor of the particular client 1 disappears. Therefore, each client 1, upon complete transmission of a plurality of printing jobs, is released from the communication connection with the server 3 without waiting for the complete processing of all the printing jobs transmitted from the particular client 1. After complete transmission of the printing jobs, therefore, the power supply can be turned off immediately. As a result, the user of the client 1, who is desirous of going out or returning home immediately after complete transmission of the printing jobs and can check the actual printing result later, can conveniently turn off the power of the client 1.

In the additional spooler 33, the printing jobs received from the clients 1 through the network 2 and held therein are sequentially transferred to the standard spooler 31 on first-come-first-served basis.

The standard spooler 31 included in the operating system mounted on the server 3 to manage the printing jobs based on the “shared printer” function, upon receipt of printing jobs from the additional spooler 33, converts the printing jobs sequentially into raster data and transmits them to the back-end unit 32, which in turn outputs the raster data as a print data to the printer 4. The printer 4 carries out the printing operation based on the print data.

The shared print server control program and the shared print server control method according to this invention, with the provision of the additional server 33 on the server 3, may operate with a communication protocol equivalent to that of the “shared printer” function included in the operating system mounted on the server 3.

As described above, the additional spooler 33 arranged on the server 3 based on the shared print server control program and the shared print server control method according to the invention cuts off the communicative connection with a given client 1 without delay or immediately after sequentially receiving all the printing jobs transmitted from the client 1.

This process of cutting off the communicative connection, though capable of conveniently releasing the client 1 from the communicative connection with the server 3 as described above, would make it impossible for the client 1 to recognize an error which may occur during the processing operation of the printing jobs.

In view of this, the additional spooler 33 arranged on the server 3 based on the shared print server control program and the shared print server control method according to the invention periodically accesses the API of the standard spooler 31 and monitors the printer status, so that upon occurrence of an error during the processing operation of the printing jobs, the error information is notified to the client 1 in accordance with a predetermined protocol. In response to this, the client 1 has installed therein a predetermined resident program to provide a printer status display UI (user interface) 16 capable of receiving and indicating the error information in accordance with a predetermined protocol.

As a result, the user of the client 1 can monitor as to whether the processing operation of the printing jobs is proceeding normally or not, and upon occurrence of an error in the printer during the processing operation of the printing jobs, can be immediately informed of the fact and take an appropriate measure quickly by grasping the specifics of the error accurately and immediately.

With the shared print server control program and the shared print server control method according to the invention, therefore, as compared with the “shared printer” function of the operating system, not only the convenience described above but also the function equivalent to the “shared printer” function of the operating system can secured with regard to the detection of an error which may occur during the processing operation of the printing jobs.

Even while the shared print server control method according to the invention is being carried out, i.e. the shared print server control program according to the invention is operating, however, the “shared printer” function of the operating system can be validated by the user operation, etc. If the “shared printer” function of the operating system is so validated, the inconveniences described below are caused.

Specifically, assume that the additional spooler 33 is arranged on the server 3 based on the shared print server control program and the shared print server control method according to the invention and that the printer status display UI 16 is provided on the client 1 based on the resident program to permit the user of the client 1 to monitor the printer status. In the case where the “shared printer” function of the operating system is validated under such conditions, all the printing jobs on the printer status monitor (job window) displayed on the monitor of the client 1 based on the “shared printer” function of the operating system would be erased and the job window would disappear as soon as they are received by the additional spooler 33 on the server 3 and the communicative connection with the client 1 is cut off. At the same time, the conflicting situation occurs in which the printing jobs are displayed in standby mode (waiting for printing) on the printer status display UI 16 on the client 1.

Although both of these display conditions are functionally normal, the user may be confused without understanding this functional structure.

It is, therefore, undesirable to provide the printer status display UI 16 on the client 1 while at the same time validating the “shared printer” function of the operating system.

In view of this, in the shared print server control program and the shared print server control method according to the invention, as long as the invalidity of the “shared printer” function of the operating system is confirmed, the printer status display UI 16 is displayed on the client 1, while upon detection of the validity of the “shared printer” function of the operating system, the printer status display UI 16 on the client 1 is rendered to disappear or invisible.

An explanation is made below about a specific process of operation to display or not to display the printer status display UI 16 arranged on the client 1 in accordance with the validity or invalidity of the “shared printer” function of the operating system in the shared print server control program and the shared print server control method according to the invention.

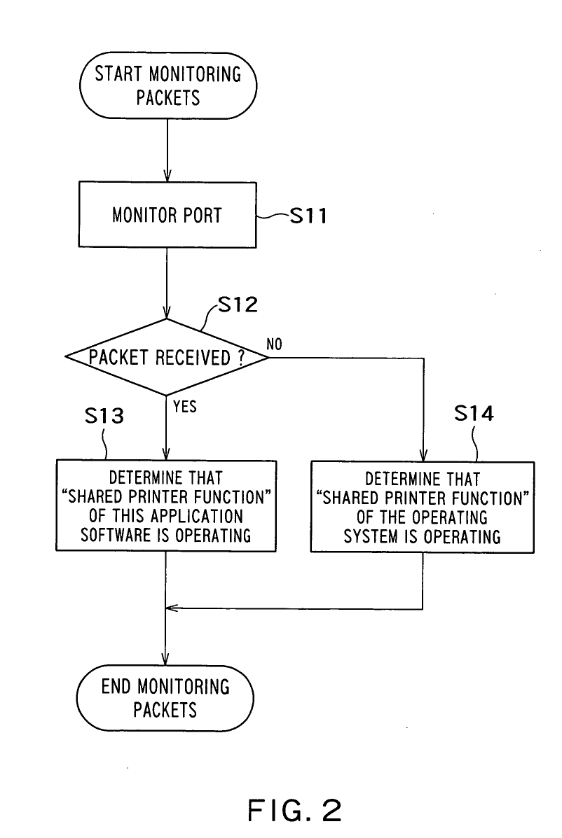

FIG. 2 is a flowchart showing the operation steps for monitoring as to whether the “shared printer” function of the shared printer system is based on the shared print server control program and the shared print server control method according to the invention or on the “shared printer” function of the operating system.

In the shared print server control program and the shared print server control method according to the invention, the additional spooler 33 is arranged on the server 3 and the printer status display UI 16 is mounted on the client 1. As long as the additional spooler 33 is in operation while the “shared printer” function of the operating system remains invalid, packets are transmitted from the additional spooler 33 to a predetermined communication port at predetermined intervals. In the case where the “shared printer” function of the operating system is valid, on the other hand, no packets are transmitted from the additional spooler 33. The packet monitor function based on the resident program for the printer status display UI 16 monitors as to whether packets are received at predetermined intervals by the predetermined communication port thereby to determine whether the “shared printer” function of the shared printer system in operation is based on the shared print server control program and the shared print server control method according to the invention or on the “shared printer” function of the operating system.

Once the shared printer system enters into operation, the packets begin to be monitored which are transmitted at predetermined intervals to a predetermined communication port from the additional spooler 33 arranged on the server 3 based on the shared print server control program and the shared print server control method according to the invention thereby to monitor the predetermined communication port constituting the packet destination (step S11).

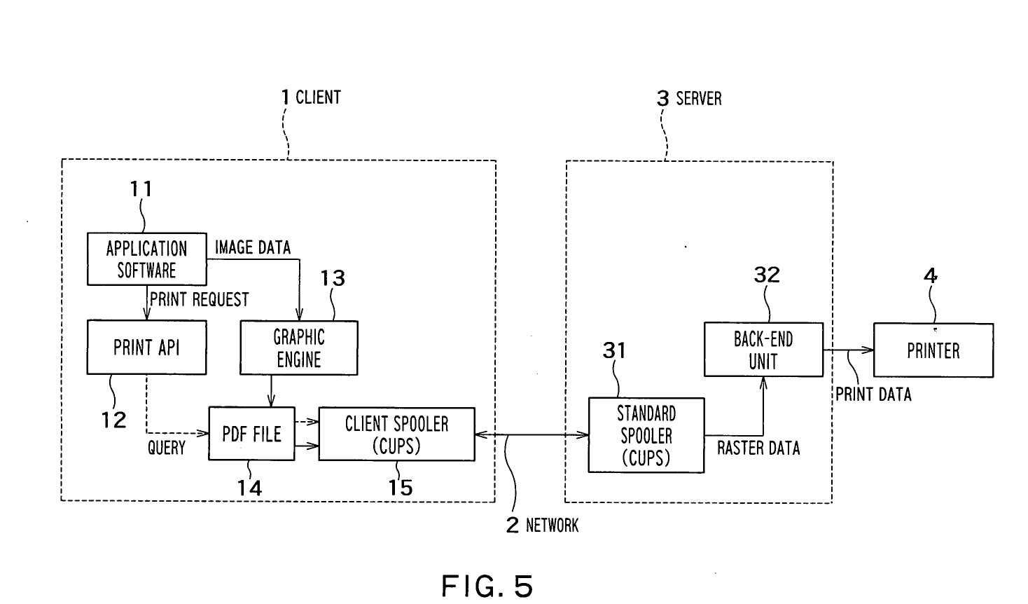

Specifically, the communication port is monitored as to whether it receives the packets at predetermined intervals or not (step S12), and as long as the packets are so received, it is determined that the shared print server control program according to the invention (hereinafter referred to also as “this application software” which is different from the “application software 11” shown in FIGS. 1, 5) is operating (step S13).

In the case where the packets are not so received, on the other hand, it is determined that the “shared printer” function of the operating system is validated (step S14).

In the manner described above, the monitor operation is performed to determine whether the “shared printer” function of the shared printer system is based on the shared print server control program and the shared print server control method according to the invention or on the “shared printer” function of the operating system.

In the case where the result of monitoring shows that the “shared printer” function of the shared printer system is based on the shared print server control program and the shared print server control method according to the invention, i.e. in the case where the shared print server control program according to the invention is operating, assume that the printer status monitor (job window) on the client 1 is on display based on the “shared printer” function of the operating system. Then, the aforementioned conflict occurs with the printer status display UI 16 on the client 1 based on the resident program associated with the shared print server control program and the shared print server control method according to the invention.

In view of this, according to the shared print server control program and the shared print server control method according to the invention, upon determination that as the result of monitoring, the shared print server control program according to the invention are in operation on the server 3, the process (“process” means the object to be assigned the hardware resources by the operating system) of the printer status monitor displayed on the client 1 based on the “shared printer” function of the operating system is monitored. Once this process become active, i.e. the user operation becomes possible, a predetermined alarm is issued by alert display, alert sound and the like informing the user of the client 1 that the printer status monitor is not originally valid.

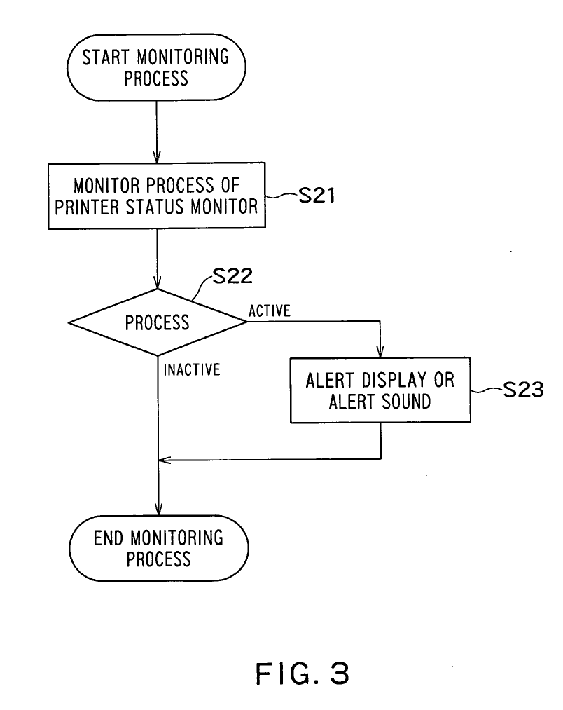

FIG. 3 is a flowchart showing the operation steps for monitoring the process of the printer status monitor displayed on the monitor of the client 1 based on the “shared printer” function of the operating system.

The monitor operation is performed to determine whether the “shared printer” function of the shared printer system is based on the shared print server control program and the shared print server control method according to the invention or on the “shared printer” function of the operating system. In the case where the result of monitoring shows that the shared print server control program according to the invention is in operation on the server 3, the process of the printer status monitor displayed on the client 1 based on the “shared printer” function of the operating system is monitored (step S21).

Specifically, for example, the resident program for providing the printer status display UI 16 on the client 1 according to the shared print server control program and the shared print server control method according to the invention is desirably equipped with the function to monitor the process of the printer status monitor.

In the case where the process of the printer status monitor is monitored and found not to be active, i.e. in the case where the process remains inactive, no specific operation is performed. Once the particular process becomes active, i.e. the user operation becomes possible, however, a predetermined alarm is issued by alert display, alert sound and the like, thereby informing the user of the client 1 that the printer status monitor is not originally valid (step S23).

This process monitor operation and the alarm generation can prevent the confusion on the part of the user due to the conflict between the display of the printer status monitor on the client 1 based on the “shared printer” function of the operating system and the display of the printer status display UI 16 on the client 1.

In the shared print server control program and the shared print server control method according to the invention, as shown in the flowchart of FIG. 2, the monitor operation is performed to determine whether the “shared printer” function of the shared printer system is based on the shared print server control program and the shared print server control method according to the invention or on the “shared printer” function of the operating system. As a result, assume that the monitor result shows that the “shared printer” function of the shared printer system is based on the shared print server control program and the shared print server control method according to the invention and that as shown in the flowchart of FIG. 3, the process of the printer status monitor displayed on the monitor of the client 1 based on the “shared printer” function of the operating system is monitored with the result that the particular process becomes active in spite of the fact that the shared print server control program according to the invention is operating. Then, a predetermined alarm such as alert display, alert sound and the like is issued.

In the shared print server control program and the shared print server control method according to the invention, however, the monitor operation is performed continuously even in the case that the predetermined alarm such as alert display, alert sound and the like is generated to determine whether the “shared printer” function of the shared printer system is based on the shared print server control program and the shared print server control method according to the invention or on the “shared printer” function of the operating system. Upon detection that the “shared printer” function of the operating system is valid, the predetermined alarm such as alert display, alert sound and the like is stopped, and the printer status display UI 16 on the client 1 based on the resident program associated with the shared print server control program and the shared print server control method according to the invention is rendered to disappear or invisible.

As a result, the confusion on the part of the user due to the conflict between the display of the printer status monitor on the client 1 based on the “shared printer” function of the operating system and the printer status display UI 16 on the client 1 can always be prevented.

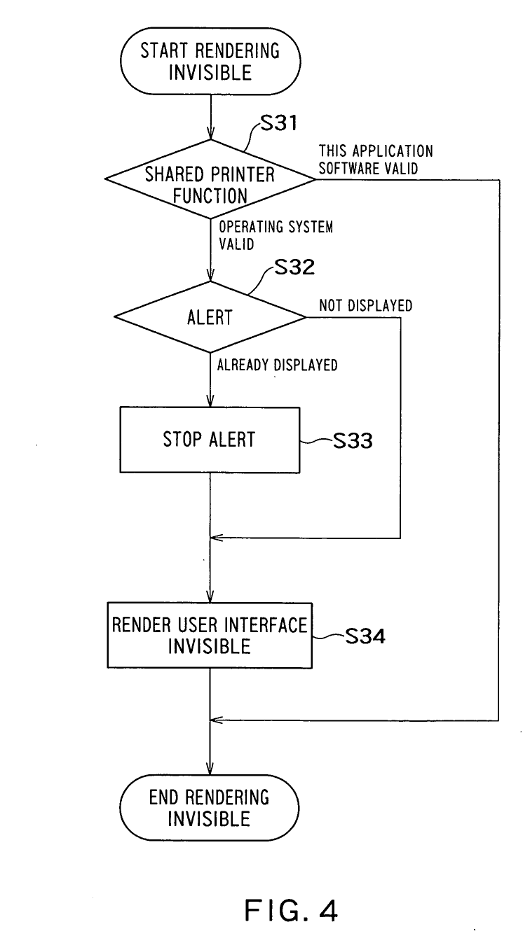

FIG. 4 is a flowchart showing the operation steps for continuously monitoring as to whether the “shared printer” function of the shared printer system is based on the shared print server control program and the shared print server control method according to the invention or on the “shared printer” function of the operating system so that the printer status display UI 16 on the client 1 is rendered invisible.

According to the shared print server control program and the shared print server control method according to the invention, even after determination that the “shared printer” function of the shared printer system is based on the shared print server control program and the shared print server control method according to the invention, the monitor operation is continued to determine whether the “shared printer” function of the shared printer system is based on the shared print server control program and the shared print server control method according to the invention or on the “shared printer” function of the operating system (step S31), and upon determination that the “shared printer” function of the shared printer system is based on the shared print server control program and the shared print server control method according to the invention, the previous operating condition is maintained.

In the case where the result of the continuous monitor operation shows that the “shared printer” function of the shared printer system is based on the “shared printer” function of the operating system, on the other hand, the predetermined alarm such as alert display, alert sound and the like, if already generated, is stopped (step S33).

Assume, on the other hand, that it is determined that the “shared printer” function of the shared printer system is based on the “shared printer” function of the operating system and the alarm is stopped or no alarm is generated. Then, the printer status display UI 16 on the client 1 based on the resident program associated with the shared print server control program and the shared print server control method according to the invention is immediately rendered to disappear or invisible (step S34).

As described above, according to the shared print server control program and the shared print server control method according to the invention, the monitor operation is performed continuously even in the case that the predetermined alarm such as alert display, alert sound and the like is generated to determine whether the “shared printer” function of the operating system is validated or not, and upon detection that the “shared printer” function of the operating system is validated, the printer status display UI 16 on the client 1 based on the resident program associated with the shared print server control program and the shared print server control method according to the invention is rendered to disappear or invisible. Therefore, the confusion on the part of the user due to the conflict between the display of the printer status monitor on the client based on the “shared printer” function of the operating system and the printer status display UI 16 arranged on the client 1 can always be prevented.

The above-described steps of the operation according to the shared print server control program and the shared print server control method according to the invention are executed by a CPU (central processing unit) included in the server 3 and the client 1 based on the shared print server control program according to the invention in collaboration with the operating system mounted on the server 3 and the client 1.

As described above, in the shared print server control program and the shared print server control method according to the invention, the printing jobs can be smoothly and quickly processed as viewed from the client side of the shared printer system without changing the standard function or the printing framework of the operating system, while at the same time holding the error information notification function without causing any confusion on the part of the user.

What is claimed is:

1. A shared print server control program used for a shared printer system including a server connected with a printer and at least one client connected to the server through a network, realizing an operation of the shared printer system in such a manner that:
an additional spooler for assisting in the management of printing jobs is arranged on the server in addition to a standard spooler included in the operating system mounted on the server for managing the printing jobs based on the shared printer function;
the additional spooler, upon sequential receipt of all the printing jobs transmitted from the client, cuts off the communication connection with the client without waiting for the end of the processing operation of the previously received printing jobs;
the additional spooler in operation transmits packets indicating that the additional spooler is in operation, to a predetermined communication port at predetermined intervals; and
the additional spooler monitors the printer status after starting the processing operation of the printing jobs, and upon occurrence of an error in the printer during the processing operation of the printing jobs, notifies the error information according to a predetermined protocol to the client with a predetermined resident program installed therein.

2. The shared print server control program according to claim 1,
wherein the resident program is such that the print status display UI to display the printer status and the error information is arranged on the client.

3. The shared print server control program according to claim 2,
wherein the resident program is such that the monitor operation is performed to determine whether the predetermined communication port receives the packets at predetermined intervals thereby to determine whether the additional spooler is in operation or the shared printer function of the operating system is valid.

4. The shared print server control program according to claim 3,
wherein the resident program is such that upon determination that the result of the monitoring shows that the additional spooler is in operation on the server, the process of the printer status monitor displayed on the monitor of the client based on the shared printer function of the operating system is monitored, and upon activation of the process, a predetermined alarm is generated.

5. The shared print server control program according to claim 4,
wherein the resident program is such that the alarm is stopped upon determination that the continues monitor operation shows that the shared printer function of the operating system is valid.

6. The shared print server control program according to claim 3,
wherein the resident program is such that the printer status display UI on the client is rendered invisible upon determination that the continues monitor operation shows that the shared printer function of the operating system is valid.

7. The shared print server control program according to claim 1,
wherein the additional spooler sequentially transfers the received printing jobs to the standard spooler.

8. A shared print server control method used for a shared printer system including a server connected with a printer and at least one client connected to the server through a network, comprising the steps of:
arranging an additional spooler on the server for assisting in the management of printing jobs in addition to a standard spooler included in the operating system on the server for managing the printing jobs based on the shared printer function;
the additional spooler in operation transmitting packets indicating that the additional spooler is in operation, to a predetermined communication port at predetermined intervals;
the additional spooler, upon transmission of the printing jobs from the client to the server, sequentially receiving all the printing jobs from the client without waiting for the end of the processing operation of the previously received printing jobs;
the additional spooler cutting off the communicative connection with the client immediately after sequentially receiving all the printing jobs transmitted from the client; and
the additional spooler monitoring the printer status after starting the processing operation of the printing jobs, and upon occurrence of an error in the printer during the processing operation of the printing jobs, notifying an error information in accordance with a predetermined protocol to the client with a predetermined resident program installed therein.

9. The shared print server control method according to claim 8, further comprising the step of the resident program being such that the printer status display UI for displaying the printer status and the error information is arranged on the server.

10. The shared print server control method according to claim 9, further comprising the step of the resident program monitoring whether the predetermined communication port receives the packets at predetermined intervals thereby to determine whether the additional spooler is in operation or the shared printer function of the operating system is valid.

11. The shared print server control method according to claim 10, further comprising the step of the resident program being such that upon determination that the result of the monitoring shows that the additional spooler is in operation on the server, the process of the printer status monitor displayed on the monitor of the client based on the shared printer function of the operating system is monitored, and upon activation of the process, a predetermined alarm is generated.

12. The shared print server control method according to claim 11, further comprising the step of the resident program stopping the alarm upon determination, as the result of continuous monitor operation, that the shared printer function of the operating system is valid.

13. The shared print server control method according to claim 10, further comprising the step of the resident program rendering the printer status display UI on the client invisible upon determination, as the result of continuous monitor operation, that the shared printer function of the operating system is valid.

14. The shared print server control method according to claim 8, further comprising the step of the additional spooler sequentially transferring the received printing jobs to the standard spooler.
